(19) United States
(12) Patent Application Publication
(10) Pub. No.: US 2026/0002887 A1
(43) Pub. Date: Jan. 1, 2026

(54) X-RAY IMAGING APPARATUS

(71) Applicant: SHIMADZU CORPORATION, Kyoto-shi (JP)

(72) Inventor: Tanaka Fumiaki, Kyoto-shi (JP)

(21) Appl. No.: 19/204,787

(22) Filed: May 12, 2025

(30) Foreign Application Priority Data
May 13, 2024 (JP) 2024-077774

(51) Int. Cl. G01N 23/04

(52) U.S. Cl. CPC G01N 23/04; G01N 2223/1016; G01N 2223/306; G01N 2223/308; G01N 2223/309; G01N 2223/402; G01N 2223/408

(57) ABSTRACT

An X-ray imaging apparatus includes: an irradiation unit that irradiates a subject with X-rays; a detection unit that detects the X-rays transmitted through the subject; a support section that supports the irradiation unit and the detection unit to face each other and is rotationally movable about each of two axes orthogonal to each other; a setting unit that sets an angle at which the subject is irradiated with the X-rays; a control unit that controls the support section such that the angle at which the subject is irradiated with the X-rays is set to the set angle and controls the irradiation unit such that an X-ray imaging operation of the subject is performed; a storage unit that stores, in a case where a plurality of the X-ray imaging operations are performed, the set angle in each of the X-ray imaging operations; and a display unit that sorts and displays a plurality of the angles stored in the storage unit, in which, in a case where an angle displayed on the display unit is designated, the setting unit sets the designated angle as the angle.

### BACKGROUND OF THE INVENTION

### Field of the Invention

The present application is based on, and claims priority from JP Application Serial Number 2024-077774, filed May 13, 2025, the disclosure of which is hereby incorporated by reference herein in its entirety.

The technology of the present disclosure relates to an X-ray imaging apparatus.

### Background Art

An X-ray imaging apparatus disclosed in JP-A-2001-292984 stores an X-ray image obtained through X-ray imaging in a storage device together with an irradiation angle of X-rays at the time of the X-ray imaging. During the next imaging, the X-ray imaging apparatus reads the X-ray image and the irradiation angle from the storage device, and displays the read X-ray image and irradiation angle on a monitor of an operation console. In a case where the displayed irradiation angle is selected, the X-ray imaging apparatus controls a support device and performs X-ray imaging such that the X-rays are emitted at the irradiation angle.

In addition, Pamphlet of International Publication WO. 2024/042823 discloses that a display on which an operation of selecting an irradiation angle of X-rays can be performed is installed on a side portion of a bed of a subject.

### SUMMARY OF THE INVENTION

As described in JP-A-2001-292984, in a case where the operator desires to perform imaging at the irradiation angle of the X-rays used in the previous imaging at the time of the next imaging, a set of the X-ray image and the irradiation angle is displayed on the monitor of the operation console.

However, in a case where a plurality of the sets of the X-ray images and the irradiation angles are displayed, it takes a long time to select a desired irradiation angle from among the plurality of sets.

For example, since a plurality of the irradiation angles are displayed, it takes a long time to determine which of the irradiation angles is the desired irradiation angle, and as a result, it takes a long time to select the desired angle.

In addition, as described in Pamphlet of International Publication WO. 2024/042823, an X-ray imaging apparatus in which the display that allows the selection operation is provided on the side portion of the bed of the subject is becoming more widespread. However, such a display has a small display region size. In a case where a plurality of sets are displayed as in JP-A-2001-292984, only a small number of sets are displayed at a time, and in order to find a desired irradiation angle, it is necessary to switch the display until a set associated with the desired irradiation angle is displayed. As a result, it takes a long time to select a desired irradiation angle.

The technology of the present disclosure is made in view of the above facts, and an object of the technology of the present disclosure is to provide an X-ray imaging apparatus capable of selecting a desired irradiation angle from among a plurality of irradiation angles at which X-ray imaging has been performed in the past, in a shorter time than in the related art.

In order to achieve the above object, an X-ray imaging apparatus according to a first aspect of the technology of the present disclosure includes: an irradiation unit that irradiates a subject with X-rays; a detection unit that is disposed to face the irradiation unit and detects the X-rays transmitted through the subject; a support section that supports the irradiation unit and the detection unit to face each other and is rotationally movable about each of two axes orthogonal to each other; a setting unit that sets an angle at which the subject is irradiated with the X-rays; a control unit that controls the support section such that the angle at which the subject is irradiated with the X-rays is set to the set angle and controls the irradiation unit such that an X-ray imaging operation of the subject is performed; a storage unit that stores, in a case where a plurality of the X-ray imaging operations are performed, the set angle in each of the X-ray imaging operations; and a display unit that sorts and displays a plurality of the angles stored in the storage unit, in which, in a case where an angle displayed on the display unit is designated, the setting unit sets the designated angle as the angle.

An X-ray imaging apparatus according to a second aspect includes: a bed on which a subject is placed; an irradiation unit that irradiates the subject with X-rays; a detection unit that is disposed to face the irradiation unit and detects the X-rays transmitted through the subject; a support section that supports the irradiation unit and the detection unit to face each other and is rotationally movable about each of two axes orthogonal to each other; a setting unit that sets an angle at which the subject is irradiated with the X-rays; a control unit that controls the support section such that the angle at which the subject is irradiated with the X-rays is set to the set angle and controls the irradiation unit such that an X-ray imaging operation of the subject is performed; a storage unit that stores, in a case where a plurality of the X-ray imaging operations are performed, the set angle in each of the X-ray imaging operations; and a display unit that is provided on a side surface of the bed and that displays a plurality of the angles stored in the storage unit without displaying an X-ray image obtained by performing the X-ray imaging operation, in which, in a case where an angle displayed on the display unit is designated, the setting unit sets the designated angle as the angle.

The technology of the present disclosure can select a desired irradiation angle from among a plurality of irradiation angles at which X-ray imaging has been performed in the past, in a shorter time than in the related art.

### BRIEF DESCRIPTION OF THE DRAWINGS

FIG. 1 is a block diagram showing an example of an X-ray imaging system according to an embodiment.

FIG. 2 is a front view showing an example of an overall configuration of an X-ray imaging apparatus according to the embodiment.

FIG. 3 is a right side view showing an example of the overall configuration of the X-ray imaging apparatus.

FIG. 4A is a block diagram showing an example of a control system of the X-ray imaging apparatus.

FIG. 4B is a functional block diagram showing an example of processing contents of a determination unit, a communication processing unit, a reading unit, a sorting processing unit, and a display processing unit of a processor of the X-ray imaging apparatus.

FIG. 4C is a functional block diagram showing an example of processing contents of the determination unit, an angle control unit, an imaging processing unit, a storage processing unit, and the communication processing unit of the processor of the X-ray imaging apparatus.

FIG. 5 is a schematic view illustrating an example of a rotational movement direction of a C-arm.

FIG. 6 is a schematic diagram illustrating an example of a rotational movement direction of each of CRA and CAU of the C-arm.

FIG. 7 is a schematic diagram illustrating an example of a rotational movement direction of each of RAO and LAO of the C-arm.

FIG. 8 is a conceptual diagram showing an example of stored contents of an angle storage unit of the X-ray imaging apparatus.

FIG. 9 is a conceptual diagram showing an example of stored contents of a storage device of a server.

FIG. 10 is a perspective view showing an example of a schematic configuration of an operation console.

FIG. 11 is a diagram showing an example of a display screen of a touch panel.

FIG. 12 is a diagram showing display contents of a monitor, and a relationship between sizes of display regions of the monitor and the touch panel.

FIG. 13 is a flowchart of an example of an X-ray imaging processing program.

FIG. 14 is a diagram showing an example of display contents of an irradiation angle display unit of the touch panel that displays a plurality of set angles in chronological order of date and time of X-ray imaging.

FIG. 15 is a conceptual diagram showing an example of stored contents of an angle storage unit of an X-ray imaging apparatus according to a modification example.

FIG. 16 is a conceptual diagram showing an example of stored contents of a storage device of a server according to a modification example.

### DETAILED DESCRIPTION OF THE INVENTION

Hereinafter, an embodiment of the technology of the present disclosure will be described with reference to the drawings.

### Configuration

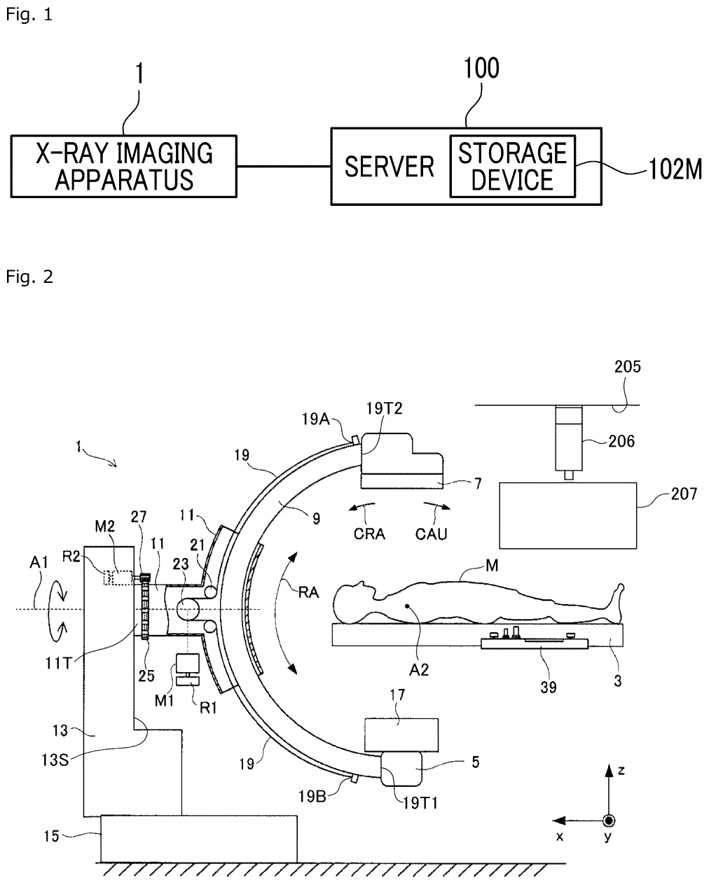

FIG. 1 is a block diagram showing an example of an X-ray imaging system according to the embodiment. As shown in FIG. 1, the X-ray imaging system includes an X-ray imaging apparatus 1 that performs X-ray imaging of an imaging target (that is, a lesion site (that is, an affected area)) of a subject M, and a server device (hereinafter, referred to as a “server”) 100. The server 100 includes a storage device 102M.

The storage device 102M is an example of a “storage unit” and a “second storage unit” of the technology of the present disclosure. The X-ray imaging apparatus 1 is an example of an “X-ray imaging apparatus” according to the technology of the present disclosure.

The X-ray imaging is to irradiate an imaging target with X-rays at a set angle and perform contrast imaging. This contrast imaging allows identification, evaluation, and treatment of the imaging target. The “X-ray imaging” is a concept including fluoroscopy.

In addition, the imaging target (that is, the lesion site) is, for example, a blood vessel of the heart, and angina pectoris or myocardial infarction may occur in the blood vessel. The imaging target is not limited to the blood vessel of the heart, and may be a blood vessel of the groin, arm, wrist, or the like. Furthermore, the imaging target is not limited to the blood vessel, but may be other body parts.

The set angle is an irradiation angle of X-rays set for X-ray imaging.

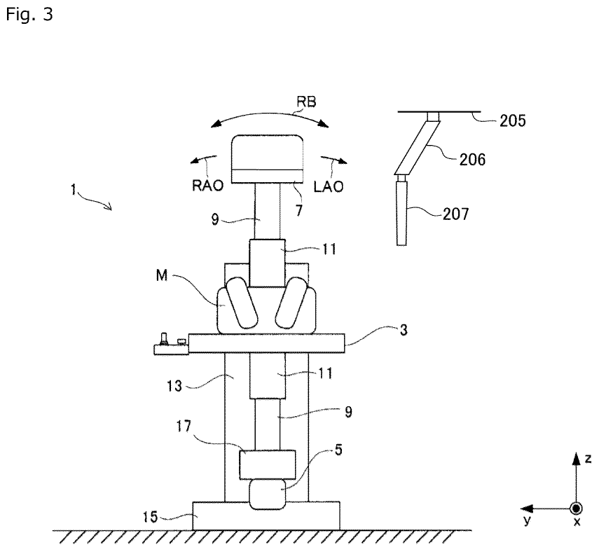

FIG. 2 is a front view showing an example of an overall configuration of the X-ray imaging apparatus 1 according to the embodiment. FIG. 3 is a right side view showing an example of the overall configuration of the X-ray imaging apparatus 1.

As shown in FIGS. 2 and 3, the X-ray imaging apparatus 1 includes a bed 3. The subject M is placed on the bed 3 in a supine posture and along a longitudinal direction of the bed 3.

The bed 3 is an example of a “bed” of the technology of the present disclosure.

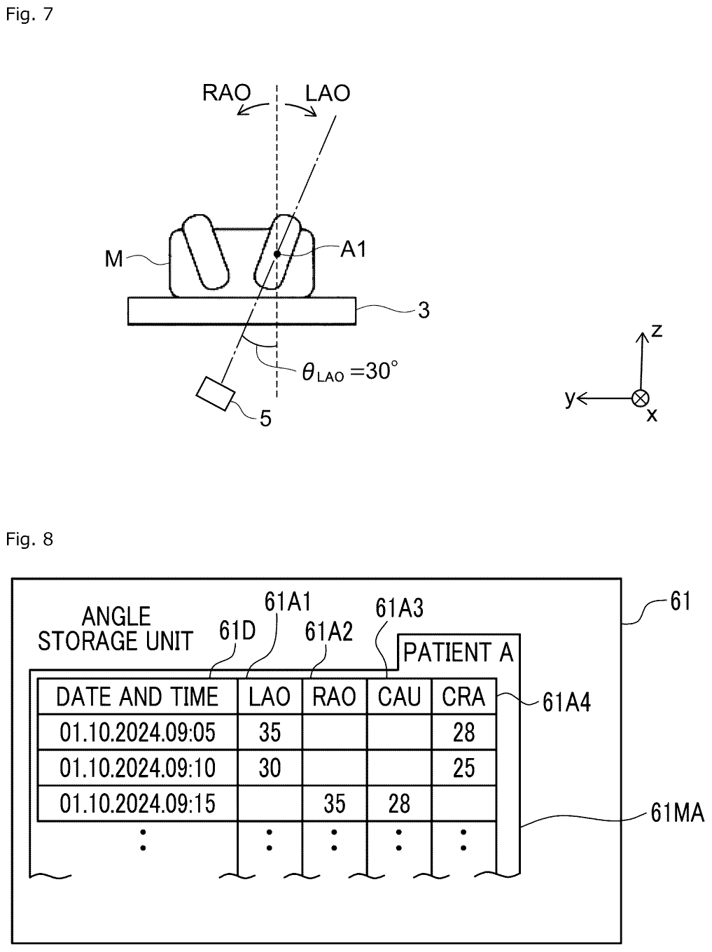

The longitudinal direction of the bed 3 is referred to as an x direction, a lateral direction of the bed 3 is referred to as a y direction, and a direction perpendicular to the x direction and the y direction is referred to as a z direction (also referred to as a height direction, a vertical direction, or an up-down direction). An x-y plane is referred to as a horizontal plane. An axis parallel to the x direction is referred to as a first horizontal axis A1 (see FIGS. 2 and 7). An axis parallel to the y direction is referred to as a second horizontal axis A2 (see FIGS. 2 and 6). The first horizontal axis A1 and the second horizontal axis A2 are orthogonal to each other.

In the X-ray imaging apparatus 1, an X-ray tube 5 and an X-ray detector 7 are disposed to face each other with the bed 3 interposed therebetween. The X-ray tube 5 irradiates the subject M with X-rays. The X-ray detector 7 detects the X-rays emitted from the X-ray tube 5 and transmitted through the subject M, converts the X-rays into an electrical signal, and outputs the electrical signal as an X-ray detection signal. An example of the X-ray detector 7 is a flat panel detector (FPD). A collimator 17 is provided below the X-ray tube 5. The collimator 17 limits the X-rays emitted from the X-ray tube 5 to a predetermined shape. An example of the shape for limiting the X-rays is a pyramidal cone shape.

The X-ray tube 5 and the X-ray detector 7 are examples of an “irradiation unit” and a “detection unit” of the technology of the present disclosure, respectively.

Each of the X-ray tube 5 and the X-ray detector 7 is provided on a C-arm 9. The C-arm 9 has a curved, substantially C-like shape. The X-ray tube 5 is provided on one end 19T1 side of the C-arm 9. The X-ray detector 7 is provided on the other end 19T2 side of the C-arm 9. The C-arm 9 is held by an arm holding member 11. The C-arm 9 and the arm holding member 11 are configured such that the C-arm 9 slides along an arcuate path of the C-arm 9 indicated by reference numeral RA in FIG. 2. By sliding movement in a direction indicated by the reference numeral RA, the C-arm 9 is rotationally moved about the second horizontal axis A2 as shown in FIGS. 2 and 6.

The arm holding member 11 is disposed on a side surface portion 13S of a support column 13. The arm holding member 11 and the support column 13 are configured such that the arm holding member 11 is rotationally movable about the first horizontal axis A1. The C-arm 9 rotationally moves about the first horizontal axis A1 by the rotational movement of the arm holding member 11.

As described above, in the present embodiment, the C-arm 9 rotationally moves independently about two orthogonal axes (that is, the first horizontal axis A1 and the second horizontal axis A2). As a result, the X-ray tube 5 can irradiate the subject M with the X-rays in any direction.

As shown in FIGS. 2 and 3, a state in which the X-ray tube 5 and the X-ray detector 7 are positioned in the vertical direction with respect to the subject M is referred to as an initial state of the C-arm 9. Then, a rotational movement position of the C-arm 9 in the initial state is set as an initial position of the C-arm 9. Regarding the initial position of the C-arm 9, a rotational movement angle of the C-arm 9 is set to 0° for each of the rotational movements about the first horizontal axis A1 and the second horizontal axis A2.

The support column 13 is supported by a support base 15 disposed on a floor surface. The support column 13 and the support base 15 are configured such that the support column 13 can move horizontally in the y direction. The arm holding member 11 and the C-arm 9 move in the y direction in accordance with the horizontal movement of the support column 13.

Next, a rotational movement mechanism of the C-arm 9 will be described. The rotational movement of the C-arm 9 about the second horizontal axis A2 is achieved by a drive mechanism inside the arm holding member 11. A part of the belt 19 is housed inside the arm holding member 11. One end 19A of the belt 19 is fixed to an X-ray detector 7 side of the C-arm 9, and the other end 19B of the belt 19 is fixed to an X-ray tube 5 side of the C-arm 9. The belt 19 is stretched over a drive roller 23 via a guide roller 21.

A drive motor M1 and a rotary encoder R1 are provided inside the arm holding member 11. For convenience of description, the drive motor M1 and the rotary encoder R1 are shown to be positioned outside the arm holding member 11 in FIG. 2. The drive motor M1 causes the drive roller 23 to rotationally move. The rotary encoder R1 detects a rotation direction and a rotation amount of the drive motor M1. The C-arm 9 rotationally moves about the second horizontal axis A2 via the belt 19 by the rotation of the drive motor M1.

The rotational movement of the C-arm 9 about the first horizontal axis A1 is achieved by rotationally moving the arm holding member 11 about the first horizontal axis A1. A base portion 11T of the arm holding member 11, that is, an end portion on a side opposite to a side on which the C-arm 9 is held, is supported by the side surface portion 13S of the support column 13 so as to be rotationally movable. A gear 25 is fixed to the arm holding member 11 near the base portion 11T.

The gear 25 meshes with a pinion gear 27. The pinion gear 27 is attached to an output shaft of the drive motor M2 provided inside the support column 13. The C-arm 9 rotationally moves about the first horizontal axis A1 together with the arm holding member 11 by the rotation of the drive motor M2. The rotation direction and the rotation amount of the drive motor M2 are detected by the rotary encoder R2.

The C-arm 9, the arm holding member 11, the drive motor M1, the drive roller 23, the gear 25, the pinion gear 27, and the drive motor M2 are an example of a “support section” of the technology of the present disclosure.

The X-ray imaging apparatus 1 includes a monitor 207 that is rotationally movably attached to a ceiling 205 of an examination room in which the X-ray imaging apparatus 1 is disposed, via a rotational movement axis 206. An example of the monitor 207 is a liquid crystal monitor. The monitor 207 is not limited to being attached to the ceiling 205 of the examination room, and may be attached to a movable carriage.

The monitor 207 is an example of “another display unit” of the technology of the present disclosure.

The X-ray imaging apparatus 1 includes an operation console 39.

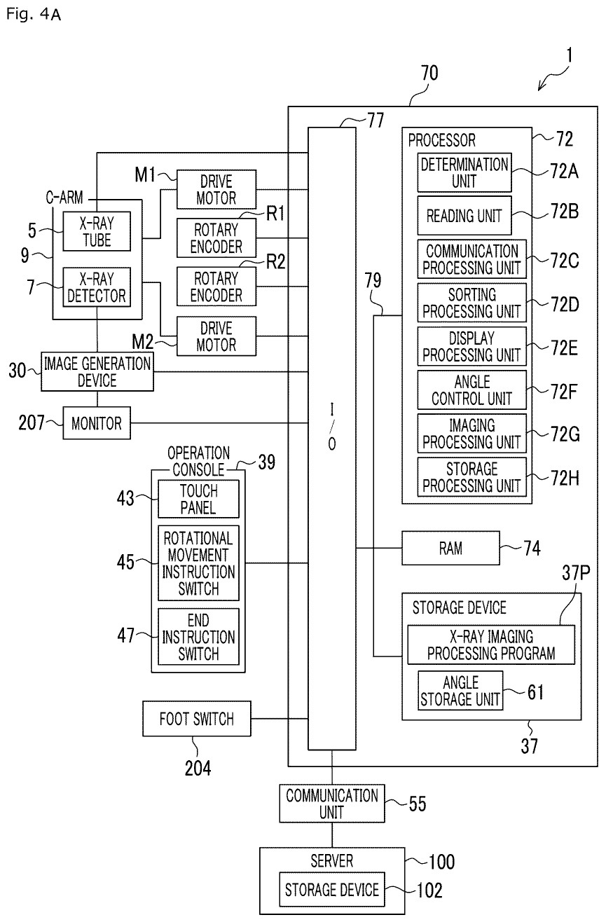

Next, a control system of the X-ray imaging apparatus 1 will be described. FIG. 4A is a block diagram showing an example of a control system of the X-ray imaging apparatus 1. As shown in FIG. 4A, the control system of the X-ray imaging apparatus 1 includes a computer 70. The computer 70 includes a processor 72, a RAM 74, a storage device 37, and an input/output (I/O) port 77. The processor 72, the RAM 74, the storage device 37, and the input/output (I/O) port 77 are communicatively connected to each other via a bus 79.

The processor 72 is an example of a “control unit” of the technology of the present disclosure.

The processor 72 is a processing device including a digital signal processor (DSP), a central processing unit (CPU), and a graphics processing unit (GPU), and the DSP and the GPU operate under the control of the CPU and execute X-ray imaging processing. Here, although the processing device including the DSP, the CPU, and the GPU is taken as an example of the processor 72, this is merely an example, and the processor 72 may be one or more CPUs and DSPs integrated with a GPU function, or one or more CPUs and DSPs that are not integrated with a GPU function, or may be equipped with a tensor processing unit (TPU).

The RAM 74 is a memory in which information is temporarily stored, and is used by the processor 72 as a work memory. Examples of the RAM 74 include a dynamic random access memory (DRAM) and a static random access memory (SRAM).

The storage device 37 is a non-volatile storage device. The storage device 37 stores an X-ray imaging processing program 37P and an angle storage unit 61.

The angle storage unit 61 is an example of a “storage unit” and a “first storage unit” of the technology of the present disclosure.

The processor 72 includes a determination unit 72A, a reading unit 72B, a communication processing unit 72C, a sorting processing unit 72D, a display processing unit 72E, an angle control unit 72F, an imaging processing unit 72G, and a storage processing unit 72H.

The drive motors M1 and M2, the rotary encoders R1 and R2, the X-ray tube 5, the X-ray detector 7, an image generation device 30, and the monitor 207 are connected to the input/output (I/O) port 77. The image generation device 30 is connected to the X-ray detector 7 and the monitor 207.

The processor 72 controls the rotation directions and the rotation amounts of the drive motors M1 and M2.

The processor 72 detects the rotational movement position of the C-arm 9 based on the rotation direction and the rotation amount of the drive motor M1 detected by the rotary encoder R1 and the rotation direction and the rotation amount of the drive motor M2 detected by the rotary encoder R2. The rotational movement position of the C-arm 9 is specified by a rotational movement direction and a rotational movement angle of the C-arm 9.

The processor 72 controls an X-ray dose emitted by the X-ray tube 5 and a timing of the emission of the X-rays.

The image generation device 30 is provided in a rear stage of the X-ray detector 7, and generates an X-ray image based on the X-ray detection signal output from the X-ray detector 7. The monitor 207 is provided in a rear stage of the image generation device 30 and displays the X-ray image generated by the image generation device 30.

A touch panel 43, a rotational movement instruction switch 45, and an end instruction switch 47 of the operation console 39 are connected to the input/output (I/O) port 77 (see also FIG. 10).

A foot switch 204 and a communication unit 55 are connected to the input/output (I/O) port 77. The communication unit 55 is connected to a communication unit (not shown) of the server 100 via a communication line.

The processor 72 reads the X-ray imaging processing program 37P from the storage device 37 and executes the read X-ray imaging processing program 37P on the RAM 74, thereby functioning as the determination unit 72A, the reading unit 72B, the communication processing unit 72C, the sorting processing unit 72D, the display processing unit 72E, the angle control unit 72F, the imaging processing unit 72G, and the storage processing unit 72H.

Next, processing contents of each functional unit of the processor 72 of the X-ray imaging apparatus 1 will be described. FIG. 4B is a functional block diagram showing an example of the processing contents of the determination unit 72A, the communication processing unit 72C, the reading unit 72B, the sorting processing unit 72D, and the display processing unit 72E of the processor 72 of the X-ray imaging apparatus. FIG. 4C is a functional block diagram showing an example of the processing contents of the determination unit 72A, the angle control unit 72F, the imaging processing unit 72G, the storage processing unit 72H, and the communication processing unit 72C of the processor 72 of the X-ray imaging apparatus.

As shown in FIG. 4B, the determination unit 72A determines whether or not a set angle is stored in the angle storage unit 61 of the own apparatus (X-ray imaging apparatus 1). The reading unit 72B reads the set angle from the angle storage unit 61. The communication processing unit 72C receives a set angle from the server 100 via the communication unit 55. The sorting processing unit 72D sorts the set angle read from the angle storage unit 61 and the set angle received from the server 100. The display processing unit 72E displays the set angles on the touch panel 43 in the sorted order.

As shown in FIG. 4C, the determination unit 72A determines whether or not an irradiation angle is set from an operation on the touch panel 43. In a case where the determination unit 72A determines that the irradiation angle is set, the angle control unit 72F controls the rotation directions and the rotation amounts of the drive motors M1 and M2 such that the irradiation angle becomes the set angle. The determination unit 72A determines whether or not an imaging instruction is issued by determining whether or not the foot switch 204 is operated. In a case where it is determined that the imaging instruction has been issued, the imaging processing unit 72G controls the X-ray tube 5 to emit X-rays. The subject M is irradiated with the X-rays emitted from the X-ray tube 5, and the X-ray detector 7 outputs an X-ray detection signal to the image generation device 30. The image generation device 30 generates an X-ray image in accordance with an instruction of the imaging processing unit 72G. The monitor 207 displays the X-ray image generated by the image generation device 30 in accordance with the instruction of the imaging processing unit 72G. The storage processing unit 72H stores the set angle in the angle storage unit 61 of the own apparatus. The communication processing unit 72C controls the communication unit 55 such that the set angle is transmitted to the server 100. The server 100 that has received the set angle stores the set angle.

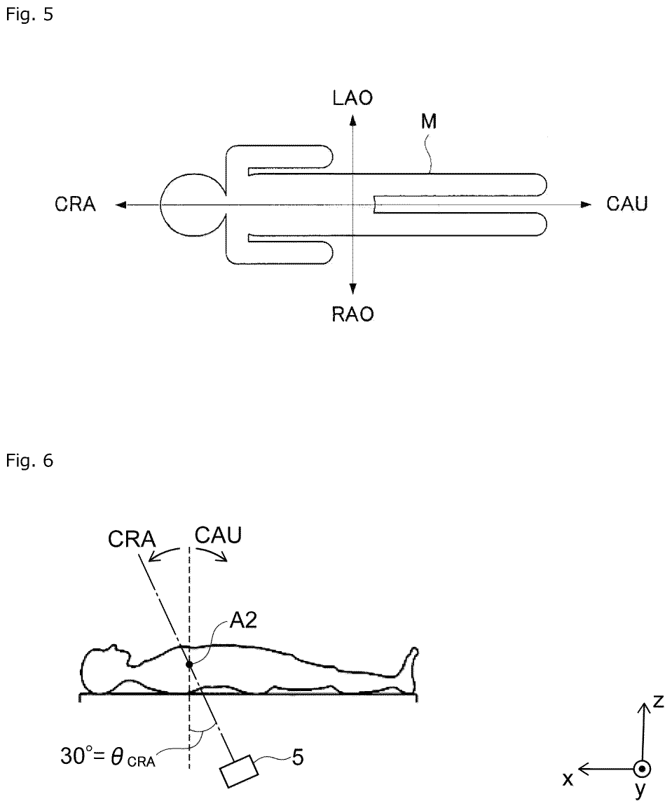

Next, the rotational movement direction of the C-arm 9 will be described. As shown in FIGS. 5 and 6, in the rotational movement direction of the C-arm 9, a direction toward the head side about the second horizontal axis A2 is hereinafter referred to as “CRA” (Cranial), and a direction toward the foot side is hereinafter referred to as “CAU” (Caudal). As shown in FIGS. 5 and 7, in the rotational movement direction of the C-arm 9, a rotational movement direction to the left as viewed from the head side to the foot side about the first horizontal axis A1 is hereinafter referred to as “LAO” (Left Anterior Oblique), and a rotational movement direction to the right is hereinafter referred to as “RAO” (Right Anterior Oblique). As described above, the rotational movement direction of the C-arm 9 is expressed by a combination of CRA or CAU and LAO or RAO. The irradiation angle of the X-rays from the X-ray tube 5 is specified by the CRA or CAU and the LAO or RAO.

Next, stored contents of the angle storage unit 61 in the storage device 37 will be described. FIG. 8 is a conceptual diagram showing an example of the stored contents of the angle storage unit 61. As shown in FIG. 8, the angle storage unit 61 includes a region 61D that stores information on date and time when X-ray imaging is performed, and regions 61A1 to 61A4 that store information on each angle of CRA, CAU, LAO, and RAO. In addition, FIG. 8 shows a form in which, regarding a patient A, information on the date and time when X-ray imaging is performed, and information on the irradiation angle of the X-ray from the X-ray tube 5 during the X-ray imaging are stored. As described above, the irradiation angle of the X-rays is defined by the CRA or CAU and the LAO or RAO. The angle storage unit 61 stores each information on the date and time and the irradiation angle when X-ray imaging is performed in one examination on the subject M (for example, the patient A). Therefore, in a case where the examination is ended (that is, the execution of the X-ray imaging processing program is ended), data stored in the angle storage unit 61 is deleted.

In the angle storage unit 61, a plurality of sets of the date and time and the irradiation angle when X-ray imaging is performed are stored in one examination. The number of the plurality of sets is not fixed to, for example, three.

Here, the examination refers to performing X-ray imaging of an imaging target (that is, a lesion site) of the subject M and examining a state of the imaging target from an X-ray image. In general, the imaging target is subjected to a plurality of X-ray imaging operations in one examination. In a case where one examination is ended, the next examination is performed after a certain period of time (for example, several months) has elapsed.

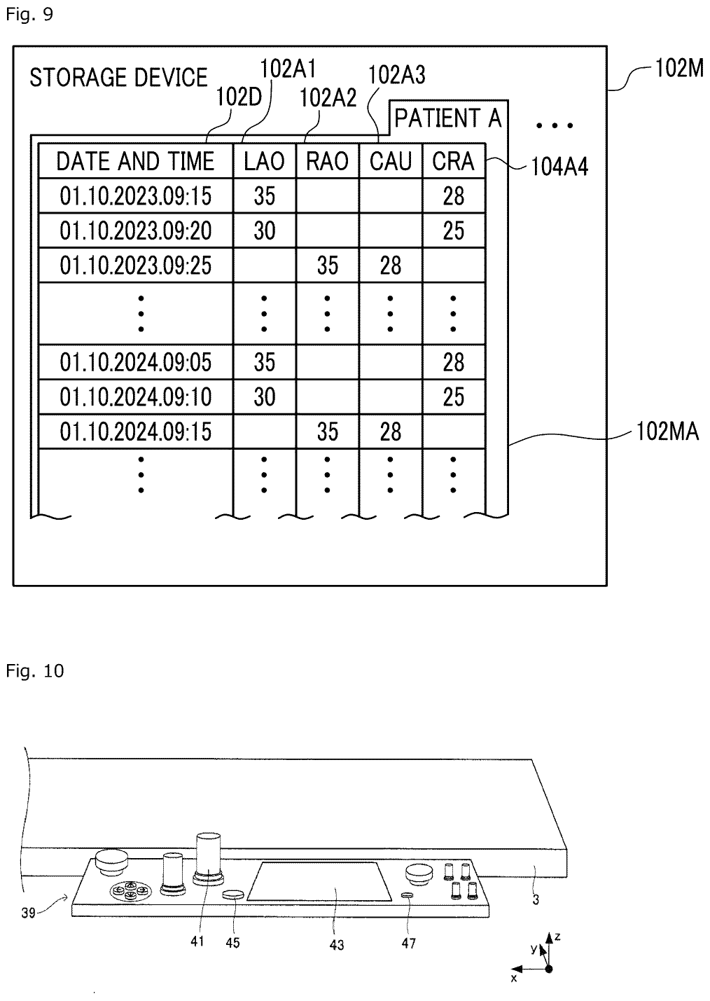

Next, stored contents of the storage device 102M of the server 100 will be described. FIG. 9 is a conceptual diagram showing an example of the stored contents of the storage device 102M of the server 100. As shown in FIG. 9, the storage device 102M includes a region 102D that stores information on the date and time when X-ray imaging is performed for each subject M (that is, in association with identification information of the subject M), and regions 102A1 to 102A4 that store information on each angle of CRA, CAU, LAO, and RAO. FIG. 9 shows a form in which, regarding the patient A, information on the date and time when X-ray imaging is performed, and information on the irradiation angle of the X-rays (that is, CRA or CAU and LAO or RAO) from the X-ray tube 5 at the time of the X-ray imaging are stored. The storage device 102M stores information on a history of each of the date and time and the irradiation angle when the X-ray imaging is performed in a plurality of previous examinations on the subject M (for example, the patient A).

Next, the operation console 39 will be described. The operation console 39 is used to input an instruction from an operator regarding an operation of the X-ray imaging apparatus 1. The processor 72 controls each unit of the control system of the X-ray imaging apparatus 1 in accordance with the instruction input by the operator using the operation console 39. Examples of the operation console 39 include a keyboard input type panel, a touch input type panel, a mouse, a dial, a changeover type switch, and a push button type switch.

In the present embodiment, the operation console 39 is disposed on a side portion of the bed 3 as shown in FIG. 2. The operator operates the operation console 39 in a state of standing near the bed 3. By disposing the operation console 39 on the bed 3, the operator can perform various operations on the X-ray imaging apparatus 1 while performing a surgical procedure such as a catheter procedure or an examination on the subject M.

The operation console 39 is not limited to being disposed on the side portion of the bed 3, and the operation console 39 may be disposed on an upper surface of a movable carriage. In addition, the operation console 39 is not limited to a configuration in which the operation console 39 is disposed on a side portion of a long side of the bed 3, and the operation console 39 may be disposed on a side portion of a short side of the bed 3.

Next, main operating devices provided in the operation console 39 will be described. FIG. 10 is a perspective view showing an example of a schematic configuration of the operation console 39. As shown in FIG. 10, the operation console 39 includes an arm operation lever 41, the touch panel 43, the rotational movement instruction switch 45, and the end instruction switch 47.

The arm operation lever 41 is configured to be tiltable in forward, backward, leftward, and rightward directions, and is a lever for adjusting the rotational movement position of the C-arm 9. As an example, the operator grasps the arm operation lever 41 and tilts the arm operation lever 41 in the forward direction (that is, inward), so that the C-arm 9 is instructed to rotationally move in an LAO direction (see FIG. 7). The operator grasps the arm operation lever 41 and tilts the arm operation lever 41 toward a front side, so that the C-arm 9 is instructed to rotationally move in an RAO direction (see FIG. 7). The rotational movement angle of the C-arm 9 changes according to an angle at which the arm operation lever 41 is tilted or a time for which the arm operation lever 41 is tilted. In addition, FIG. 7 shows a form in which the C-arm 9 is rotationally moved in the LAO direction by an angle θ_{LAO}=30°.

In addition, the operator grasps the arm operation lever 41 and tilts the arm operation lever 41 in the leftward direction, so that the C-arm 9 is instructed to rotationally move in a CRA direction (see FIG. 6). The operator grasps the arm operation lever 41 and tilts the arm operation lever 41 in the rightward direction, so that the C-arm 9 is instructed to rotationally move in a CAU direction (see FIG. 6). In addition, FIG. 6 shows a form in which the C-arm 9 is rotationally moved in the CRA direction by an angle θ_{CRA}=30°.

By using the arm operation lever 41, the operator can manually finely adjust the rotational movement position of the C-arm 9.

The touch panel 43 performs an operation of storing the rotational movement position of the C-arm 9, and displays a plurality of icon-type switches.

The rotational movement instruction switch 45 is a push button type switch, and moves the C-arm 9 to a predetermined rotational movement position. That is, by pressing the rotational movement instruction switch 45 is pressed in a state in which a specific rotational movement position stored is selected by using the touch panel 43, the C-arm 9 rotationally moves toward the specific rotational movement position.

The end instruction switch 47 is a push button type switch, and is operated when a predetermined surgical procedure on the subject M is ended. When the operator presses the end instruction switch 47, the X-ray imaging apparatus 1 can perform an operation related to the next surgical procedure or an operation related to the end of the operation.

Although the four operation devices related to the adjustment of the rotational movement position of the C-arm 9 have been described here, the operation devices disposed in the operation console 39 are not limited to these four devices. Specifically, operation devices related to the operation of the X-ray imaging apparatus 1, such as a switch for switching on/off a main power supply, an examination start switch, a switch for setting X-ray imaging conditions, a switch for adjusting the position of the bed 3, and an emergency stop switch, are provided.

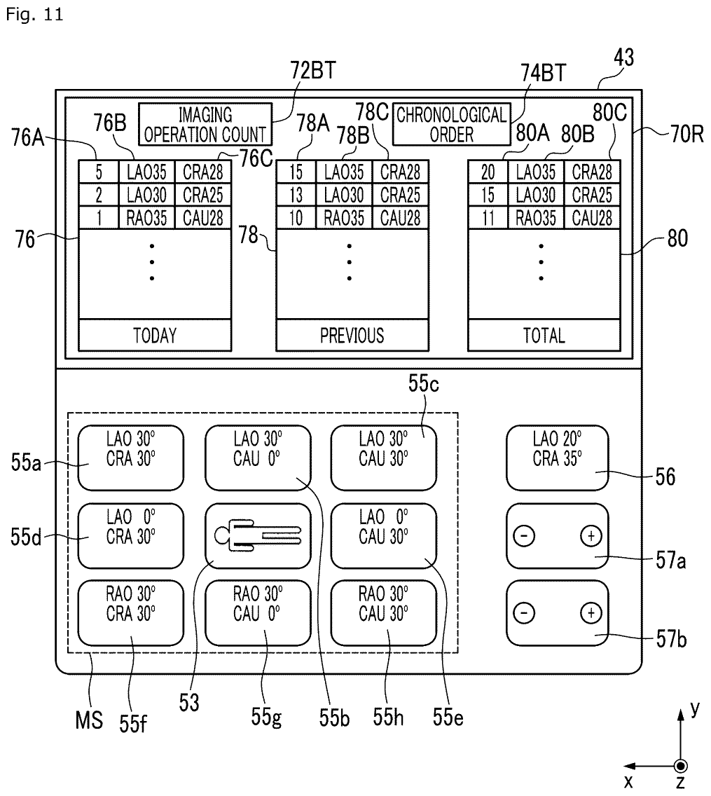

Next, a configuration of the touch panel 43 will be described in detail. FIG. 11 is a diagram showing an example of a display screen of the touch panel 43 in the initial state.

The touch panel 43 includes a set angle display unit 70R, a memory switch group MS, a display unit 56, and adjustment switches 57a and 57b.

The set angle display unit 70R is an example of a “display unit” of the technology of the present disclosure.

The memory switch group MS includes a center switch 53 and a plurality of memory switches 55a to 55h.

The center switch 53 is disposed at a center of the memory switch group MS, and displays a human-shaped symbol representing the subject M in the supine posture. The center switch 53 is used in a case of returning the C-arm 9 to the initial position.

Each of the memory switches 55a to 55h is disposed around the center switch 53. In the present embodiment, as shown in FIG. 11, the memory switch group MS includes the eight memory switches 55a to 55h. The number of memory switches 55a to 55h is not limited to eight and may be changed as appropriate.

In the memory switch group MS, each switch is associated with information on each rotational movement position. For example, the information of the memory switch 55a and an angle of 30° in each of the LAO direction and the CRA direction from the initial position shown in FIG. 2 are stored in the storage device 37 in association with each other. The information of the memory switch 55b and an angle of 30° in the LAO direction and an angle of 0° in the CAU direction from the initial position shown in FIG. 2 are stored in the storage device 37 in association with each other. Similarly, the information of the memory switches 55c to 55h and the angles in the respective directions are stored in the storage device 37 in association with each other.

The angles stored in the storage device 37 in association with the information of the memory switches 55a to 55h are representative examples of the irradiation angle for imaging a site of an examination target of the subject M.

As shown in FIG. 5, the CRA direction is a leftward direction and the LAO direction is an upward direction with respect to the position of the subject M. Therefore, the memory switch 55a in which the rotational movement position information in the CRA direction and the LAO direction is stored is disposed on an upper left side with respect to the center switch 53. Similarly, disposition positions of the memory switches 55b to 55h are also determined according to directions of the rotational movement position.

The display unit 56 and the adjustment switches 57a and 57b are for adjusting the angle defined by the memory switch group MS. For example, there are cases where the operator wants to adjust the irradiation angle of the X-rays from the X-ray tube 5 from each angle associated with the memory switches 55a to 55h. The angles stored in association with the information of the memory switches 55a to 55h as described above are representative examples of the irradiation angle for imaging the site of the examination target of the subject M. However, the lesion site of the subject M varies from person to person. For example, the lesion site may be a blood vessel of the heart, and angina pectoris or myocardial infarction may occur in the blood vessel. In such a case, since a course of the coronary artery and a shape of the stenosis region vary from person to person, evaluation and treatment may be difficult using the irradiation angles of the representative examples stored in advance. Therefore, in order to improve visibility of the lesion site, it is necessary to find an optimum angle by changing the irradiation angles of the representative examples through a manual operation.

For example, there are cases where it is considered to change the angle of 30° in the CRA direction and the angle of 30° in the LAO direction associated with the memory switch 55a to, for example, 20° and 35°, respectively. In this case, the operator once designates (that is, touches) the memory switch 55a. In this case, 30° is displayed as the angle in each of the LAO and CRA directions on the display unit 56. In a case where the angle in the LAO direction is desired to be changed from 30° to 20°, a minus (that is, −) side of the adjustment switch 57a is touched 10 times or continuously pressed. As a result, the angle in the LAO direction is changed from 30° to 20°. In a case where the angle in the CRA direction is desired to be changed from 30° to 35°, a plus (that is, +) side of the adjustment switch 57b is touched five times or continuously pressed. As a result, the angle in the CRA direction is changed from 30° to 35°. Therefore, as shown in FIG. 11, “LAO 20°” and “CRA 35°” are displayed on the display unit 56.

The angles defined by the memory switch group MS are not limited to being adjusted by using the display unit 56 and the adjustment switches 57a and 57b. For example, a numeric keypad or the like may be provided, and an optimum angle may be input using the numeric keypad or the like.

The set angle display unit 70R is a display unit that sorts and displays a plurality of set angles (angles of LAO or RAO, and CRA or CAU) for the subject M being examined, in each of the current examination and the previous examination. Specifically, the set angle display unit 70R is a display unit that sorts and displays the plurality of set angles in order of the number of times of the X-ray imaging is performed or in chronological order of the date and time of the X-ray imaging.

The set angle display unit 70R is provided with an instruction button 72BT for issuing an instruction to sort and display the plurality of set angles in order of the number of times of the X-ray imaging is performed. The set angle display unit 70R is provided with an instruction button 74BT for issuing an instruction to sort and display the plurality of set angles in chronological order of the date and time of the X-ray imaging.

FIG. 11 shows an example in which the plurality of set angles are sorted and displayed in order of the number of times of the X-ray imaging is performed.

The set angle display unit 70R includes a display region 76 that sorts and displays the plurality of set angles for the subject M being examined, during the current examination. The display region 76 includes a display section 76A that displays the number of times and display sections 76B and 76C that display the set angles.

The set angle display unit 70R includes a display region 78 that sorts and displays the plurality of set angles for the subject M being examined, in the previous examination. The display region 78 includes a display section 78A that displays the number of times and display sections 78B and 78C that display the set angles.

The set angle display unit 70R includes a display region 80 that combines, sorts, and displays the plurality of set angles during the current examination and the plurality of set angles during the previous examination for the subject M being examined. The display region 80 includes a display section 80A that displays the number of times and display sections 80B and 80C that display the set angles.

The display sections 76B, 76C, 78B, 78C, 80B, and 80C and the rotational movement instruction switch 45 are an example of a “setting unit” of the technology of the present disclosure.

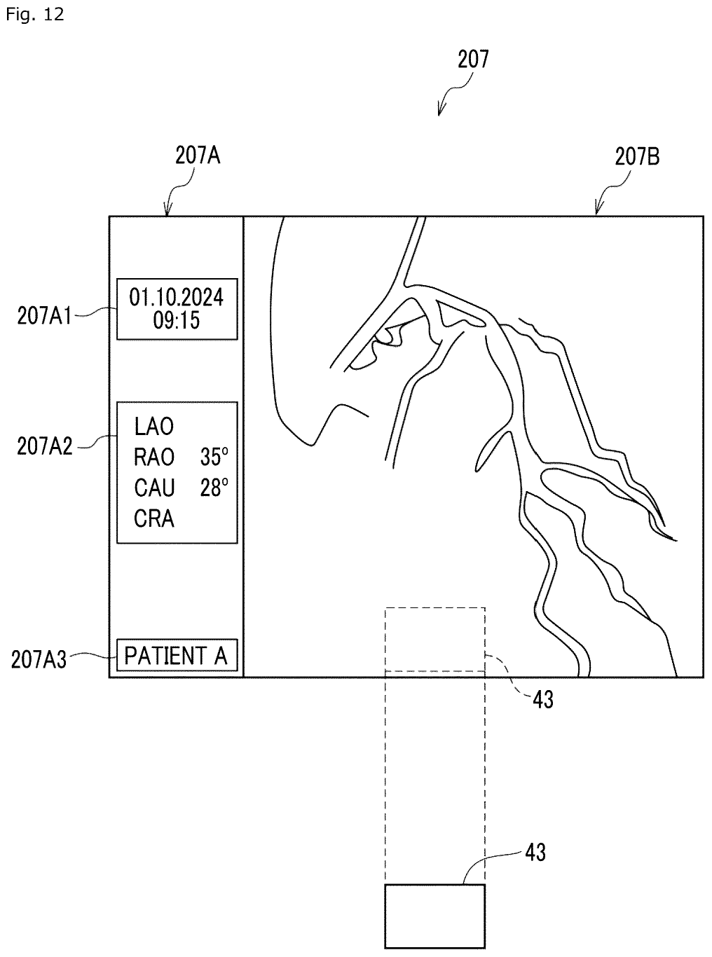

Next, a display screen of the monitor 207 will be described. FIG. 12 is a diagram showing display contents of the monitor 207, and a relationship between sizes of display regions of the monitor 207 and the touch panel 43.

As described above, the monitor 207 displays the X-ray image generated by the image generation device 30 when the X-ray imaging is performed.

The display screen of the monitor 207 includes an information display region 207A and an image display region 207B. The information display region 207A includes a display section 207A1 that displays the date and time of the X-ray imaging. For example, Jan. 10, 2024, 09:15 (2024.01.10.09:15) is displayed. The information display region 207A includes a display section 207A2 that displays the set angles of the X-rays during the X-ray imaging. For example, an angle of 35° in the RAO direction and an angle of 28° in the CAU direction are displayed. The information display region 207A includes a display section 207A3 that displays identification information of the subject M currently being examined. For example, PATIENT A (that is, identification number) is displayed.

The image display region 207B displays the X-ray image generated by the image generation device 30.

As shown in FIG. 12, the size (that is, area) of the display region of the touch panel 43 is smaller than the size of the display region of the monitor 207. The size of the display region of the touch panel 43 is, for example, 1/20 of the size of the display region of the monitor 207. Therefore, in a case where the X-ray image is displayed on the touch panel 43 and the plurality of set angles are displayed in a portion that does not overlap the X-ray image, there is a problem of inconvenience in that the operator may face inability or difficulty in visually recognizing the X-ray image and the plurality of set angles. Therefore, in the present embodiment, as shown in FIG. 11, the X-ray image is not displayed on the touch panel 43.

### Action

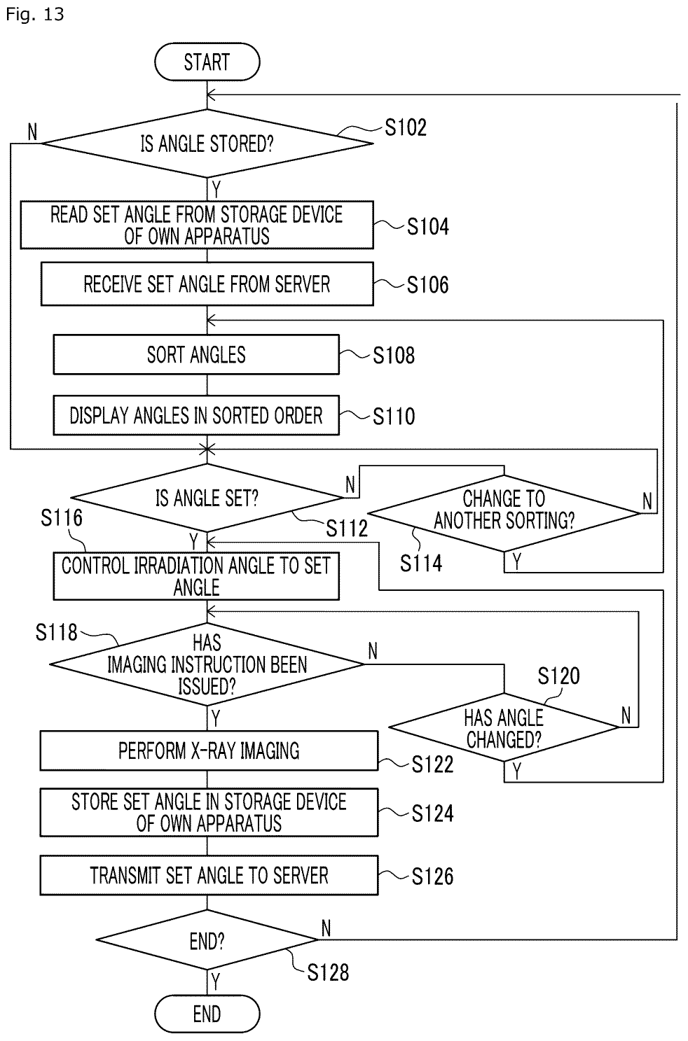

Next, an operation of the X-ray imaging system according to the present embodiment will be described. FIG. 13 is a flowchart of an example of the X-ray imaging processing program. The X-ray imaging processing program starts when a start command to start X-ray imaging processing is input, for example, by operating an examination start button (not shown). The X-ray imaging processing and an X-ray imaging processing method are performed by executing the X-ray imaging processing program. When the examination start button is operated, the identification information of the subject M is also input. As a result, the information (the date and time of X-ray imaging, the set angle, and the like) of the subject M identified by the identification information can be read.

The X-ray imaging processing program is executed for each examination. In the examination, there are cases where the lesion site of the subject M is subjected to X-ray imaging at the irradiation angles of the representative examples (that is, the irradiation angles stored in the storage device 37) and cases where the representative examples of the irradiation angles are changed during a procedure to perform X-ray imaging at an optimum irradiation angle for the subject M. The irradiation angles of the representative examples are set using the memory switches 55a to 55h. The irradiation angles of the representative examples are changed by manually operating the adjustment switches 57a and 57b to change the irradiation angles designated by the memory switches 55a to 55h.

In step S102, the determination unit 72A determines whether or not a set angle is stored in the angle storage unit 61 of the own apparatus (X-ray imaging apparatus 1). In a case where it is determined that the set angle is not stored in the angle storage unit 61 of the own apparatus (X-ray imaging apparatus 1), the X-ray imaging processing proceeds to step S112. The case where the set angle is not stored in the angle storage unit 61 occurs when the subject M is subjected to X-ray imaging for the first time in the examination.

In a case where it is determined that the set angle is stored in the angle storage unit 61 of the own apparatus (X-ray imaging apparatus 1), the X-ray imaging processing proceeds to step S104.

In step S104, the reading unit 72B reads the set angle from the angle storage unit 61.

In step S106, the communication processing unit 72C controls the communication unit 55 to transmit to the server 100 a command to read the set angle stored in the storage device 102M of the server 100 in association with the identification information of the subject M and transmit the read set angle to the X-ray imaging apparatus 1. Accordingly, the communication unit 55 transmits the command to the server 100. The server 100 that has received the command reads the set angle stored in the storage device 102M and transmits the read set angle to the X-ray imaging apparatus 1. The communication processing unit 72C receives the set angle from the server 100 via the communication unit 55.

The order of the process in step S104 and the process in step S106 is not limited to this, and may be reversed.

In step S108, the sorting processing unit 72D sorts the set angle read from the angle storage unit 61 and the set angle received from the server 100, and in step S110, the display processing unit 72E displays the set angles on the touch panel 43 in the sorted order.

Specifically, as shown in FIG. 11, the sorting processing unit 72D sorts the plurality of set angles during the current examination, and the display processing unit 72E displays the plurality of set angles during the current examination in the display region 76 of the touch panel 43 in the sorted order. In addition, the sorting processing unit 72D sorts the plurality of set angles of the previous examination, and the display processing unit 72E displays the plurality of set angles of the previous examination in the display region 78 of the touch panel 43 in the sorted order. Further, the sorting processing unit 72D combines and sorts the plurality of set angles during the current examination and the plurality of set angles of the previous examination, and the display processing unit 72E displays the combined set angles (the plurality of set angles during the current examination and the plurality of set angles of the previous examination) in the display region 80 of the touch panel 43 in the sorted order.

As described above, the sorting order includes, first, the number of times the X-ray imaging is performed, and, second, the chronological order of the date and time of the X-ray imaging. In the X-ray imaging processing program, first, the plurality of set angles are determined to be sorted in order (descending order) of the number of times the X-ray imaging is performed.

In a case where the number of times of the X-ray imaging is large, it can be said that the set angle is more likely to be set than other set angles, that is, the set angle is an important set angle for the subject M. Therefore, the operator can select a desired irradiation angle in a short period of time.

Therefore, as shown in FIG. 11, the sorting processing unit 72D sorts each of the plurality of set angles during the current examination, the plurality of set angles of the previous examination, and the set angles, which are a combination of the plurality of set angles during the current examination and the plurality of set angles of the previous examination, in order of the number of times the X-ray imaging is performed. Specifically, the sorting processing unit 72D counts the number of times the X-ray imaging is performed for each set angle from the stored contents of the angle storage unit 61. The set angles are sorted in descending order of the number of times. The display processing unit 72E displays the number of times in the display section 76A and the plurality of set angles during the current examination in the display sections 76B and 76C in the sorted order.

The display processing unit 72E displays the number of times in the display section 78A and the plurality of set angles of the previous examination in the display sections 78B and 78C in the sorted order. In addition, the number of times the X-ray imaging is performed at each set angle is counted for the plurality of set angles of the previous examination as described above. The set angles are sorted in descending order of the number of times.

The display processing unit 72E displays the number of times in the display section 80A and the set angles, which are a combination of the plurality of set angles during the current examination and the plurality of set angles of the previous examination in the display sections 80B and 80C in the sorted order. In addition, the number of times the X-ray imaging is performed at each set angle is counted for the total set angles as well. The set angles are sorted in descending order of the number of times.

In step S112, the determination unit 72A determines whether or not the irradiation angle is set by determining whether or not the set angle displayed in any of the display sections 76B and 76C, the display sections 78B and 78C, and the display sections 80B and 80C is touched and the rotational movement instruction switch 45 is operated.

In a case where it is determined that the irradiation angle is set, the X-ray imaging processing proceeds to step S116. In a case where it is determined that the irradiation angle is not set, the X-ray imaging processing proceeds to step S114.

In step S114, the determination unit 72A determines whether or not an instruction to change to another sorting is provided. In a case where it is determined that the instruction to change to another sorting has not been issued, the X-ray imaging processing returns to step S112. In a case where it is determined that the instruction to change to another sorting has been issued, the X-ray imaging processing returns to step S108.

As described above, the sorting order is first determined to be order (descending order) of the number of times the X-ray imaging is performed. There are cases where the operator wants to sort the plurality of set angles in another sorting order, that is, in chronological order of the date and time of the X-ray imaging, which is not the corresponding sorting order. In this case, the operator operates the instruction button 74BT (see FIG. 11). As a result, the determination in step S114 becomes positive (Y in step S114). In this case, in step S108, the sorting processing unit 72D sorts the plurality of set angles during the current examination and the plurality of set angles of the previous examination in chronological order of the date and time of the X-ray imaging. In step S110, the display processing unit 72E displays the plurality of set angles during the current examination and the plurality of set angles of the previous examination in chronological order of the date and time of the X-ray imaging.

The chronological order of the date and time of the X-ray imaging refers to the order that is closest in time to the current date and time of the X-ray imaging.

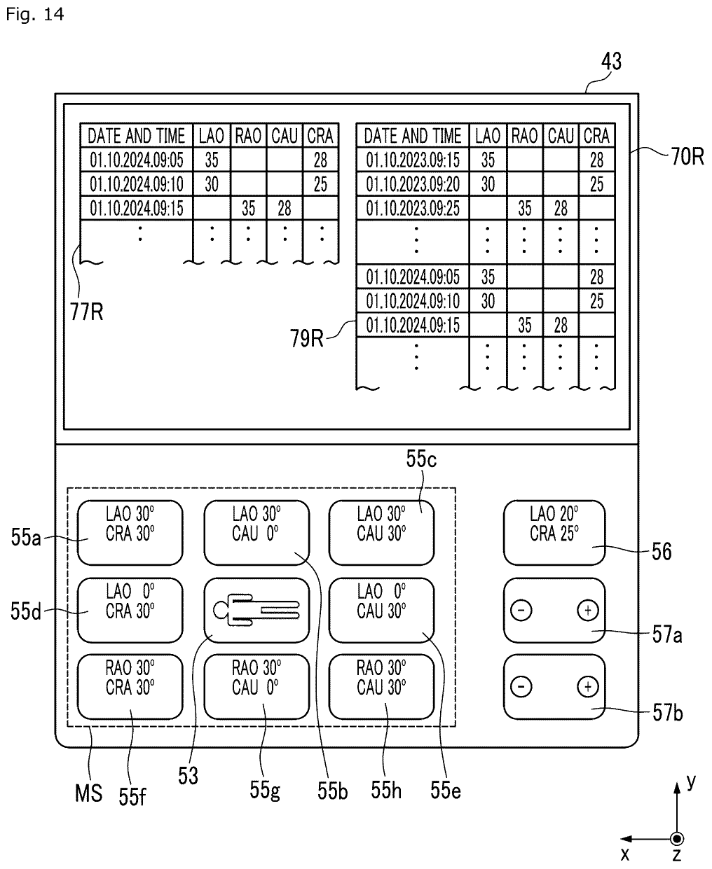

FIG. 14 is a diagram showing an example of display contents of the set angle display unit 70R of the touch panel 43 that displays the plurality of set angles in chronological order of the date and time of the X-ray imaging. As shown in FIG. 14, the set angle display unit 70R includes a display region 77R that displays the plurality of set angles during the current examination and the imaging date and time of the X-ray imaging in association with each other in chronological order of the date and time of the X-ray imaging. The set angle display unit 70R includes a display region 79R that displays the plurality of set angles of the previous examination and the imaging date and time of the X-ray imaging in association with each other in chronological order of the date and time of the X-ray imaging.

Therefore, in step S110, the display processing unit 72E displays the plurality of set angles and the imaging date and time during the current examination and the plurality of set angles and the imaging date and time of the previous examination in the display regions 77R and 79R in chronological order of the date and time of X-ray imaging. In this case, as will be described later, when the determination in step S128 is negative and the determination process in step S114 is performed, in a case where the instruction button 72BT is operated, the determination in step S114 becomes positive, and the order of the number of times of imaging is taken as the sorting order.

In step S116, the angle control unit 72F controls the C-arm such that the irradiation angle is set to the set angle. As described above, the rotational movement position of the C-arm 9 is detected based on the rotation direction and the rotation amount of the drive motor M1 detected by the rotary encoder R1 and the rotation direction and the rotation amount of the drive motor M2 detected by the rotary encoder R2. Therefore, the angle control unit 72F controls the rotation directions and the rotation amounts of the drive motors M1 and M2 such that the irradiation angle is set to the set angle.

In step S118, the determination unit 72A determines whether or not an imaging instruction has been issued by determining whether or not the foot switch 204 is operated. In a case where it is determined that the imaging instruction has been issued, the X-ray imaging processing proceeds to step S122. In a case where it is not determined that the imaging instruction has been issued, the X-ray imaging processing proceeds to step S120. In step S120, the determination unit 72A determines whether or not the angle has been changed. Since the process of step S120 is the same as that of step S112, the description thereof will be omitted. In a case where it is determined that the angle has not been changed, the X-ray imaging processing returns to step S118. In a case where it is determined that the angle has been changed, the X-ray imaging processing returns to step S116.

In step S122, the imaging processing unit 72G performs the X-ray imaging. Specifically, the imaging processing unit 72G controls the X-ray tube 5 to emit X-rays. The X-rays emitted from the X-ray tube 5 are limited to a predetermined shape by the collimator 17 and are emitted to the subject M. The X-ray detector 7 detects the X-rays transmitted through the subject M, converts the X-rays into an electrical signal, and outputs the electrical signal to the image generation device 30 as an X-ray detection signal. The image generation device 30 generates an X-ray image based on the X-ray detection signal output from the X-ray detector 7 in accordance with an instruction from the imaging processing unit 72G. The monitor 207 displays the X-ray image generated by the image generation device 30 in the image display region 207B in accordance with the instruction from the imaging processing unit 72G. The monitor 207 displays the date and time of the X-ray imaging in the display section 207A1, displays the irradiation angle of the X-rays during the X-ray imaging in the display section 207A2, and displays the identification information of the subject M currently being examined in the display section 207A3.

In step S124, the storage processing unit 72H stores the set angle set in step S116 in the angle storage unit 61 of the own apparatus. In step S126, the communication processing unit 72C controls the communication unit 55 to transmit the set angle set in step S116 to the server 100. The server 100 that has received the set angle stores information on the date and time (current time) when the X-ray imaging is performed for each subject M in the region 102D of the storage device 102M, and stores the angle of the LAO or RAO and the angle of the CAU or CRA in the regions 102A1 to 102A4.

The order of the process of step S124 and the process of step S126 is not limited to this, and may be reversed.

In step S128, the determination unit 72A determines whether or not an instruction to end the X-ray imaging processing is issued by determining whether or not the end instruction switch 47 has been operated. In a case where it is determined that the instruction to end the X-ray imaging processing has not been issued, the X-ray imaging processing returns to step S102 and the above processes (steps S102 to S128) are performed. In a case where it is determined that the instruction to end the X-ray imaging processing has been issued, the X-ray imaging processing is ended.

### Effects

In the embodiment described above, it is possible to select a desired irradiation angle from among the plurality of set angles of the current examination and the plurality of set angles of the previous examination, that is, a plurality of irradiation angles at which the X-ray imaging has been performed in the past, in a shorter time than in the related art.

Specifically, in the related art, since a plurality of sets of X-ray images and irradiation angles are displayed, it takes a long time to determine which of the irradiation angles is the desired irradiation angle, and as a result, it takes a long time to select the desired angle. In addition, in a case where a display that allows a selection operation is provided on the side portion of the bed for the subject, the size of the display region is not large. Therefore, in a case where a plurality of sets are displayed, only a small number of sets are displayed at one time. In this case, in order to find a desired irradiation angle, it is necessary to switch the display until a set associated with the desired irradiation angle is displayed. As a result, it takes a long time to select a desired irradiation angle.

However, in the present embodiment, the plurality of irradiation angles at which the X-ray imaging has been performed in the past are sorted and displayed. Therefore, it is possible to select a desired irradiation angle from among the plurality of irradiation angles in a shorter time than in the related art. Therefore, it is possible to complete the rotational movement of the C-arm 9 for emitting X-rays at a desired irradiation angle more quickly than in the related art, and it is possible to complete the X-ray imaging in a shorter time than in the related art.

In addition, in the present embodiment, in a case where the X-ray imaging is performed, the set angle is uniformly stored in the angle storage unit 61 and the storage device 102M. Therefore, the operator does not need to determine whether or not to store the angle during the procedure.

Specifically, in the related art, there is a function of temporarily storing a plurality of (for example, three) set angles during a procedure. In this function, a stored irradiation angle is deleted after an examination ends. Since only three set angles can be temporarily stored, it is necessary to determine each time whether or not to set the set angle set for the X-ray imaging again during the same procedure, and it is also difficult to make the determination. In addition, there is an additional effort of temporarily storing the set angle for each setting. Further, in a case where the set angle temporarily stored is forgotten, the C-arm has to be moved to the angle while being adjusted, which needs an additional effort.

However, in the present embodiment, in a case where the X-ray imaging is performed, the set angle is uniformly stored in the angle storage unit 61 and the storage device 102M. Therefore, the above determination is not necessary, and the above-described additional efforts can be eliminated. Therefore, the operator can concentrate on the procedure.

As described above, even in a case where the set angle during the procedure is temporarily stored, the stored irradiation angle is deleted after the end of the examination. Therefore, in a case where it is desired to set the set angle set in the previous examination for the current examination, it is necessary to move the C-arm while adjusting the C-arm from the beginning. However, in the present embodiment, in a case where the X-ray imaging is performed, the set angle is uniformly stored in the angle storage unit 61 and the storage device 102M, and in the next examination, the plurality of stored set angles are sorted and displayed. Therefore, a desired angle may be selected from among the plurality of set angles that are sorted and displayed, and thus there is no need to move the C-arm while adjusting the C-arm from the beginning.

### Modification Examples

### First Modification Example

In the above-described embodiment, in the angle storage unit 61 in the storage device 37 of the X-ray imaging apparatus 1, as shown in FIG. 8, the information on the date and time when the X-ray imaging is performed and the information on each angle are stored in association with each other. In addition, in the storage device 102M of the server 100, as shown in FIG. 9, information on the date and time when the X-ray imaging is performed and information on each angle are stored in association with each other. The technology of the present disclosure is not limited thereto. The angle storage unit 61 and the storage device 102M may store each angle and the number of times of imaging in association with each other.

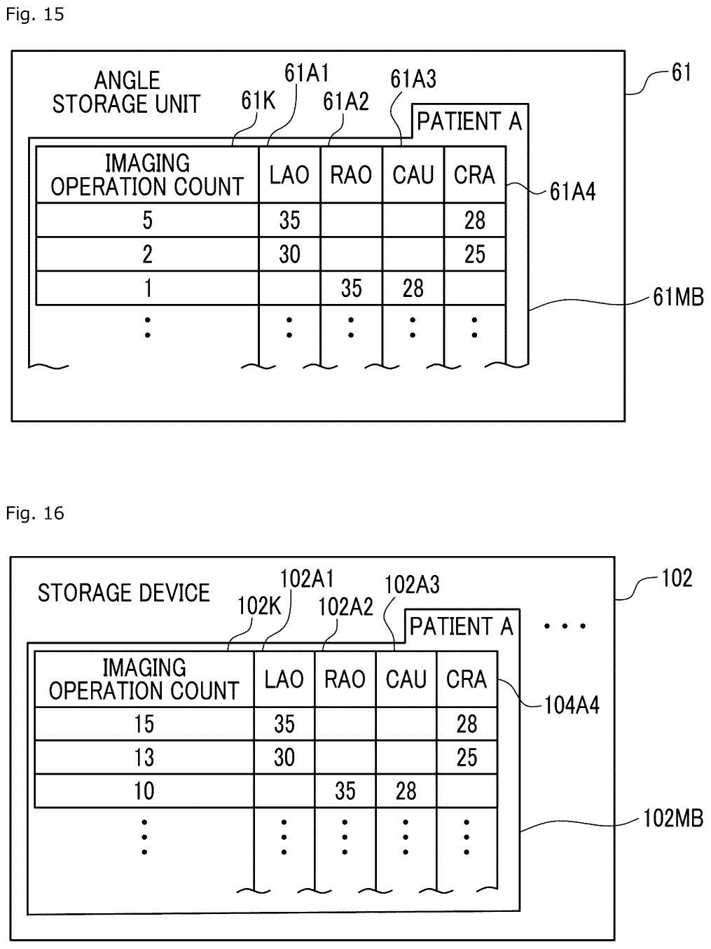

FIG. 15 is a conceptual diagram showing an example of stored contents of the angle storage unit 61 of the X-ray imaging apparatus 1 according to the present modification example. FIG. 16 is a conceptual diagram showing an example of stored contents of the storage device 102M of the server 100 of the present modification example.

As shown in FIG. 15, the angle storage unit 61 includes a region 61K that stores the number of times the X-ray imaging has been performed, and regions 61A1 to 61A4 that store information on the angles of CRA, CAU, LAO, and RAO. As shown in FIG. 16, the storage device 102M includes a region 102K that stores, for each subject M, the number of times the X-ray imaging has been performed and regions 102A1 to 102A4 that store information on the angles of CRA, CAU, LAO, and RAO.

### Second Modification Example

As described above, in a case where the X-ray imaging is performed, the set angle is uniformly stored in the angle storage unit 61 and the storage device 102M. Therefore, the set angle stored in the angle storage unit 61 and the storage device 102M may not be the set angle expected by the operator. Therefore, the set angle that is not the set angle expected by the operator may be deleted.

### Third Modification Example

In the above-described embodiment, in step S102, the determination unit 72A determines whether or not the set angle is stored in the angle storage unit 61 of the own apparatus (X-ray imaging apparatus 1). That is, the determination unit 72A determines whether or not the set angle in the same examination is stored. The technology of the present disclosure is not limited thereto. For example, the communication processing unit 72C controls the communication unit 55 such that the communication unit 55 transmits, to the server 100, an instruction to transmit the result of the determination of whether or not the set angle is stored in the storage device 102M of the server 100. Accordingly, the communication unit 55 transmits the command to the server 100. The server 100 that has received the command transmits the result of the determination as to whether or not the set angle is stored in the storage device 102M to the X-ray imaging apparatus 1. The communication processing unit 72C receives the determination result via the communication unit 55. The determination unit 72A determines whether or not the set angle is stored in the storage device 102M of the server 100 from the determination result. That is, the determination unit 72A determines whether or not the set angles in the current examination and the previous examination are stored.

### Fourth Modification Example

In the above-described embodiment, each piece of information on the date and time and the irradiation angle when the X-ray imaging is performed in each of the current and previous examinations is stored in the storage device 102M of the server 100. The technology of the present disclosure is not limited thereto. For example, each piece of the information stored in the storage device 102M may be stored in the storage device 37. Accordingly, the server 100 can be omitted.

### Fifth Modification Example

In step S112 and step S120, the determination unit 72A determines whether or not the irradiation angle is set or changed by determining whether or not the set angle displayed in any of the display sections 76B and 76C, the display sections 78B and 78C, and the display sections 80B and 80C is touched and the rotational movement instruction switch 45 is operated. The technology of the present disclosure is not limited thereto. For example, the irradiation angle may be set or changed by changing the set angle designated by touching the set angle that is displayed in any of the display sections 76B and 76C, the display sections 78B and 78C, and the display sections 80B and 80C, using the adjustment switches 57a and 57b.

### Sixth Modification Example

In the above-described embodiment, the storage device 37 of the X-ray imaging apparatus 1 does not store an image captured in the X-ray imaging. The technology of the present disclosure is not limited thereto. For example, the image captured in the X-ray imaging may be stored in the storage device 37. In a case of storing the image captured in the X-ray imaging, the image captured in the X-ray imaging is stored in association with information on a set angle and a date and time of imaging when the X-ray imaging is performed. For example, in a case where the irradiation angle is set by touching the set angle displayed in any of the display sections 76B, 76C, 78B, 78C, 80B, and 80C and operating the rotational movement instruction switch 45 and the X-ray imaging is performed, the image captured in the X-ray imaging obtained by the current X-ray imaging and the image captured in the previous X-ray imaging that is stored in association with the touched set angle may be displayed side by side on the monitor 207.

### Seventh Modification Example

In the above-described embodiment, the set angle displayed in any of the display sections 76B, 76C, 78B, 78C, 80B, and 80C of the touch panel 43 is displayed in a text form. The technology of the present disclosure is not limited thereto. For example, in a case where the set angle displayed in any of the display sections 76B, 76C, 78B, 78C, 80B, and 80C is touched, the set angle may be further displayed on the monitor 207 in a schematic diagram that imitates the irradiation angle of the X-rays from the X-ray tube 5, as shown in FIGS. 6 and 7.

### Eighth Modification Example

In the above-described embodiment, the sorting order includes, first, the order of the number of times the X-ray imaging is performed, and, second, the chronological order of the date and time of the X-ray imaging. The technology of the present disclosure is not limited thereto. For example, there is a priority. Specifically, a priority setting button is further provided. Examples of the priority setting button include a priority 1 setting button, a priority 2 setting button, and a priority 3 setting button. The operator designates the set angle to be used again in the next examination and operates any of the priority setting buttons. As a result, the priority is stored in the storage device 102M in association with the set angle. Then, in step S108, the sorting processing unit 72D sorts the set angles in descending order of priority. The sorting processing unit 72D sorts the set angles for which no associated priority is not stored, for example, in order of the number of times the X-ray imaging is performed.

### Ninth Modification Example

In the above-described embodiment, in each examination, the subject M is placed in a supine posture and along the longitudinal direction of the bed 3. In this case, it is assumed that the position, posture, and orientation of the subject M are the same as those in the previous examination. The technology of the present disclosure is not limited thereto. An imaging unit (for example, a camera or the like) that images the subject M is provided, and the processor 72 controls the camera such that the subject M is imaged each time the X-ray imaging is performed, and stores an image of the subject M in the storage device 102M in association with the set angle. In a case where the X-ray imaging is newly performed, the processor 72 compares the current image of the subject M with the image of the subject M associated with the designated set angle. The processor 72 calculates deviation amounts of the position, posture, and orientation of the subject M from the comparison result, and corrects the set angle based on the calculated deviation amounts.

### Other Modification Examples

In the above-described embodiment, a form example has been described in which the X-ray imaging processing program 37P is stored in the storage device 37, but the technology of the present disclosure is not limited to this. For example, the X-ray imaging processing program 37P may be stored in a portable computer-readable non-transitory storage medium such as an SSD, a USB memory, or a magnetic tape. The X-ray imaging processing program 37P stored in the non-transitory storage medium is installed in the computer 70. The processor 54 executes the X-ray imaging processing in accordance with the X-ray imaging processing program 37P.

In addition, the X-ray imaging processing program 37P may be stored in a storage device of another computer, server device, or the like connected to the X-ray imaging apparatus 1 via a network, and the X-ray imaging processing program 37P may be downloaded and installed in the X-ray imaging apparatus 1 in response to a request from the X-ray imaging apparatus 1.

In addition, it is not necessary to store all of the X-ray imaging processing program 37P in a storage device of another computer, server device, or the like connected to the X-ray imaging apparatus 1, or in the storage device 37, and only a part of the X-ray imaging processing program 37P may be stored.

In the above-described embodiment, although an example of the form in which the technology of the present disclosure is implemented by a software configuration has been described, the technology of the present disclosure is not limited to this, and a device including an application-specific integrated circuit (ASIC), a field-programmable gate array (FPGA), or a programmable logic device (PLD) may be applied. In addition, a combination of a hardware configuration and a software configuration may be used.

As a hardware resource for executing the X-ray imaging processing described in the above-described embodiment, various processors shown below can be used. Examples of the processor include a CPU that is a general-purpose processor that functions as a hardware resource for executing the X-ray imaging processing by executing software, that is, a program. In addition, examples of the processor include a dedicated electronic circuit that is a processor having a circuit configuration designed specifically to execute specific processing, such as an FPGA, a PLD, or an ASIC. A memory is built in or connected to any of the processors, and any of the processors executes the X-ray imaging processing by using the memory.

The hardware resource for executing the X-ray imaging processing may be configured by one of these various processors or may be configured by a combination of two or more processors of the same type or different types (for example, a combination of a plurality of FPGAs or a combination of a CPU and an FPGA). In addition, the hardware resource for executing the X-ray imaging processing may be one processor.

As an example of the configuration using one processor, first, there is a form in which one processor is configured by a combination of one or more CPUs and software, and this processor functions as the hardware resource for executing the X-ray imaging processing. Second, as represented by a system-on-a-chip (SoC) or the like, there is a form in which a processor that implements functions of an entire system including a plurality of hardware resources for executing the X-ray imaging processing on a single integrated circuit (IC) chip is used. As described above, the X-ray imaging processing is implemented by using one or more of the various processors as the hardware resource.

Further, as a hardware structure of these various processors, more specifically, an electronic circuit in which circuit elements such as semiconductor elements are combined can be used. In addition, the above-described X-ray imaging processing is merely an example. Therefore, it goes without saying that unnecessary steps may be deleted, new steps may be added, or the processing order may be changed within a range that does not deviate from the gist.

The above-described contents and the above-shown contents are detailed descriptions of parts related to the technology of the present disclosure and are merely examples of the technology of the present disclosure. For example, the description of the above-described configurations, functions, actions, and effects is a description of an example of the configurations, functions, actions, and effects of the parts related to the technology of the present disclosure. Therefore, it goes without saying that unnecessary parts may be deleted, new elements may be added, or replacements may be made to the above-described contents and the above-shown contents within a range that does not deviate from the gist of the technology of the present disclosure. In addition, in order to avoid confusion and to facilitate understanding of the parts related to the technology of the present disclosure, in the above-described contents and the above-shown contents, the description of common technical knowledge or the like that does not require particular explanation in order to enable the implementation of the technology of the present disclosure is omitted.

All documents, patent applications, and technical standards described in the present specification are incorporated in the present specification by reference to the same extent as in a case where individual documents, patent applications, and technical standards were specifically and individually stated to be incorporated by reference.

### Aspects

It is understood by those skilled in the art that each of the above-described embodiments is a specific example of the following aspects.

### First Aspect

An X-ray imaging apparatus including:
an irradiation unit that irradiates a subject with X-rays;
a detection unit that is disposed to face the irradiation unit and detects the X-rays transmitted through the subject;
a support section that supports the irradiation unit and the detection unit to face each other and is rotationally movable about each of two axes orthogonal to each other;
a setting unit that sets an angle at which the subject is irradiated with the X-rays;
a control unit that controls the support section such that the angle at which the subject is irradiated with the X-rays is set to the set angle and controls the irradiation unit such that an X-ray imaging operation of the subject is performed;
a storage unit that stores, in a case where a plurality of the X-ray imaging operations are performed, the set angle in each of the X-ray imaging operations; and
a display unit that sorts and displays a plurality of the angles stored in the storage unit,
in which, in a case where an angle displayed on the display unit is designated, the setting unit sets the designated angle as the angle.

With the X-ray imaging apparatus according to the first aspect, it is possible to select a desired irradiation angle from a plurality of irradiation angles in which X-ray imaging has been performed in the past in a shorter time than in the related art.

### Second Aspect

The X-ray imaging apparatus according to the first aspect, in which the display unit sorts the plurality of angles in order of the number of times the X-ray imaging operation is performed or in chronological order of date and time of the X-ray imaging operation.

### Third Aspect

The X-ray imaging apparatus according to the second aspect, in which the storage unit stores the set angle and a date and time at which the X-ray imaging operation is performed at the angle in association with each other for each X-ray imaging operation.

### Fourth Aspect

The X-ray imaging apparatus according to the third aspect, in which, in a case where the plurality of angles are sorted in order of the number of times the X-ray imaging operation is performed, the display unit counts the number of times the X-ray imaging operation is performed for each identical angle based on a stored content of the storage unit.

### Fifth Aspect

The X-ray imaging apparatus according to the second aspect,
in which the display unit sorts the plurality of angles in order of the number of times the X-ray imaging operation is performed, and
the storage unit stores the set angle and the number of times the X-ray imaging operation is performed at the angle in association with each other.

### Sixth Aspect

The X-ray imaging apparatus according to any one of the first to fifth aspects,
in which the storage unit includes
   a first storage unit that stores the set angle each time the X-ray imaging operation is performed in a single examination for the subject, and
   a second storage unit that stores the set angle after the X-ray imaging operation is performed in all examinations for the subject.

### Seventh Aspect

The X-ray imaging apparatus according to the sixth aspect, in which the second storage unit is provided in an external device of the X-ray imaging apparatus.

### Eighth Aspect

The X-ray imaging apparatus according to the sixth or seventh aspect, in which the display unit displays a plurality of the angles stored in at least one of the first storage unit and the second storage unit.

### Ninth Aspect

The X-ray imaging apparatus according to any one of the first to eighth aspects, in which the storage unit stores the set angle for each of the same subjects.

### Tenth Aspect

The X-ray imaging apparatus according to any one of the first to ninth aspects, further including: a deletion unit that selectively deletes the plurality of angles stored in the storage unit.

### Eleventh Aspect

The X-ray imaging apparatus according to any one of the first to tenth aspects, in which the storage unit does not store an X-ray image obtained by performing the X-ray imaging operation.

### Twelfth Aspect

An X-ray imaging apparatus including:
a bed on which a subject is placed;
an irradiation unit that irradiates the subject with X-rays;
a detection unit that is disposed to face the irradiation unit and detects the X-rays transmitted through the subject;
a support section that supports the irradiation unit and the detection unit to face each other and is rotationally movable about each of two axes orthogonal to each other;
a setting unit that sets an angle at which the subject is irradiated with the X-rays;
a control unit that controls the support section such that the angle at which the subject is irradiated with the X-rays is set to the set angle and controls the irradiation unit such that an X-ray imaging operation of the subject is performed;
a storage unit that stores, in a case where a plurality of the X-ray imaging operations are performed, the set angle in each of the X-ray imaging operations; and
a display unit that is provided on a side surface of the bed and that displays a plurality of the angles stored in the storage unit without displaying an X-ray image obtained by performing the X-ray imaging operation,
in which, in a case where an angle displayed on the display unit is designated, the setting unit sets the designated angle as the angle.

With the X-ray imaging apparatus according to the twelfth aspect, it is possible to prevent inability or difficulty in visually recognizing the plurality of angles in the X-ray image.

### Thirteenth Aspect

The X-ray imaging apparatus according to the twelfth aspect, further including:
another display unit that displays the X-ray image obtained by performing the X-ray imaging operation,
in which a size of the display unit is smaller than a size of the other display unit.

### Fourteenth Aspect

The X-ray imaging apparatus according to the twelfth or thirteenth aspect,
in which the storage unit stores information regarding the X-ray imaging operation, the information being at least one of information on the number of times of the X-ray imaging operation is performed and information on a time when the X-ray imaging operation is performed, and the set angle in association with each other, and
the display unit displays the set angle and the information regarding the X-ray imaging operation.

### Fifteenth Aspect

The X-ray imaging apparatus according to the thirteenth aspect,
in which the storage unit stores information regarding the X-ray imaging operation, the information being at least one of information on the number of times of the X-ray imaging operation is performed and information on a time when the X-ray imaging operation is performed, and the set angle in association with each other, and
the other display unit displays the set angle and the information regarding the X-ray imaging operation.

What is claimed is:

1. An X-ray imaging apparatus comprising:
an irradiation unit that irradiates a subject with X-rays;
a detection unit that is disposed to face the irradiation unit and detects the X-rays transmitted through the subject;
a support section that supports the irradiation unit and the detection unit to face each other and is rotationally movable about each of two axes orthogonal to each other;
a setting unit that sets an angle at which the subject is irradiated with the X-rays;
a control unit that controls the support section such that the angle at which the subject is irradiated with the X-rays is set to the set angle and controls the irradiation unit such that an X-ray imaging operation of the subject is performed;
a storage unit that stores, in a case where a plurality of the X-ray imaging operations are performed, the set angle in each of the X-ray imaging operations; and
a display unit that sorts and displays a plurality of the angles stored in the storage unit,
wherein, in a case where an angle displayed on the display unit is designated, the setting unit sets the designated angle as the angle.

2. The X-ray imaging apparatus according to claim 1,
wherein the display unit sorts the plurality of angles in order of the number of times the X-ray imaging operation is performed or in chronological order of date and time of the X-ray imaging operation.

3. The X-ray imaging apparatus according to claim 2,
wherein the storage unit stores the set angle and a date and time at which the X-ray imaging operation is performed at the angle in association with each other for each X-ray imaging operation.

4. The X-ray imaging apparatus according to claim 3,
wherein, in a case where the plurality of angles are sorted in order of the number of times the X-ray imaging operation is performed, the display unit counts the number of times the X-ray imaging operation is performed for each identical angle based on a stored content of the storage unit.

5. The X-ray imaging apparatus according to claim 2,
wherein the display unit sorts the plurality of angles in order of the number of times the X-ray imaging operation is performed, and
the storage unit stores the set angle and the number of times the X-ray imaging operation is performed at the angle in association with each other.

6. The X-ray imaging apparatus according to claim 1,
wherein the storage unit includes
a first storage unit that stores the set angle each time the X-ray imaging operation is performed in a single examination for the subject, and
a second storage unit that stores the set angle after the X-ray imaging operation is performed in all examinations for the subject.

7. The X-ray imaging apparatus according to claim 6,
wherein the second storage unit is provided in an external device of the X-ray imaging apparatus.

8. The X-ray imaging apparatus according to claim 6,
wherein the display unit displays a plurality of the angles stored in at least one of the first storage unit and the second storage unit.

9. The X-ray imaging apparatus according to claim 1,
wherein the storage unit stores the set angle for each of the same subjects.

10. The X-ray imaging apparatus according to claim 1, further comprising:
a deletion unit that selectively deletes the plurality of angles stored in the storage unit.

11. The X-ray imaging apparatus according to claim 1,
wherein the storage unit does not store an X-ray image obtained by performing the X-ray imaging operation.

12. An X-ray imaging apparatus comprising:
a bed on which a subject is placed;
an irradiation unit that irradiates the subject with X-rays;
a detection unit that is disposed to face the irradiation unit and detects the X-rays transmitted through the subject;
a support section that supports the irradiation unit and the detection unit to face each other and is rotationally movable about each of two axes orthogonal to each other;
a setting unit that sets an angle at which the subject is irradiated with the X-rays;
a control unit that controls the support section such that the angle at which the subject is irradiated with the X-rays is set to the set angle and controls the irradiation unit such that an X-ray imaging operation of the subject is performed;
a storage unit that stores, in a case where a plurality of the X-ray imaging operations are performed, the set angle in each of the X-ray imaging operations; and
a display unit that is provided on a side surface of the bed and that displays a plurality of the angles stored in the storage unit without displaying an X-ray image obtained by performing the X-ray imaging operation,
in which, in a case where an angle displayed on the display unit is designated, the setting unit sets the designated angle as the angle.

13. The X-ray imaging apparatus according to claim 12, further comprising:
another display unit that displays the X-ray image obtained by performing the X-ray imaging operation,
wherein a size of the display unit is smaller than a size of the other display unit.

14. The X-ray imaging apparatus according to claim 12 or 13,
wherein the storage unit stores information regarding the X-ray imaging operation, the information being at least one of information on the number of times of the X-ray imaging operation is performed and information on a time when the X-ray imaging operation is performed, and the set angle in association with each other, and
the display unit displays the set angle and the information regarding the X-ray imaging operation.

15. The X-ray imaging apparatus according to claim 13,
wherein the storage unit stores information regarding the X-ray imaging operation, the information being at least one of information on the number of times of the X-ray imaging operation is performed and information on a time when the X-ray imaging operation is performed, and the set angle in association with each other, and
the other display unit displays the set angle and the information regarding the X-ray imaging operation.
